(19) United States
(12) Patent Application Publication
(10) Pub. No.: US 2005/0045205 A1
(43) Pub. Date: Mar. 3, 2005

(54) Apparatus and method for cleaning printed circuit boards

(76) Inventor: Steven R. Stach, Leander, TX (US)

Correspondence Address: DAVID G. HENRY, P.O. Box 1470, 900 Washington Avenue, 7th Floor, Waco, TX, 77603-1470, US

(21) Appl. No.: 10/651,482

(22) Filed: Aug. 29, 2003

(51) Int. Cl. B08B 3/02

(52) U.S. Cl. 134/15; 134/2; 134/10; 134/26; 134/25.4; 134/64 R; 134/102.3; 134/122 R

(57) ABSTRACT

A highly compact yet fast operating washing and drying system, principally for use in cleaning and drying printed circuit boards after soldering. The system includes a bi-directional conveyor and control systems for moving to-be-processed articles past optimally spaced (for manufacturing facility space savings) washing, rinsing and drying components according to pre-programmed processing profiles (number of passes past washing nozzles, drying jets, etc.).

### BACKGROUND OF THE INVENTION

1. Field of The Invention

Applicant's invention relates to electronic manufacturing processes, and more particularly to the printed circuit board cleaning step which follows the soldering of electronic components onto a circuit board.

2. Background Information

During the assembly of components on printed circuit wiring boards, soldering fluxes are first applied to the substrate board material to insure that the solder will firmly bond the components to the wiring traces imprinted on the printed circuit board. After soldering, remaining flux residue must be removed. Ionic contamination (both positive and negative ions) can cause corrosion if not removed from the printed circuit board.

Cleaning printed circuit boards in such a context is as expensive as it is important. Not only is present circuit board cleaning equipment itself extremely expensive, but the time involved in cleaning consumes valuable manufacturing time, in an industry where, quite literally, every second counts, if the manufacturer is to be competitive. Further still, present cleaning equipment suitable for circuit board cleaning operations is either quite large, consuming valuable floor space in manufacturing facilities which tend, because of the nature of the industry, to be quite expensive on a square footage basis, or, in the case of batch cleaners, is smaller, but require very long processing times.

The referenced larger cleaning equipment are known as “in-line cleaners.” In-line cleaners work considerably faster on a per-circuit board basis than do batch cleaners, principally because, with in-line cleaners, to-be-cleaned articles pass successive banks of spray nozzles and drying elements to repeatedly expose the circuit boards to the necessary cleaning, rinsing and drying agents as articles move from one end to the other of the in-line cleaner. Also, by virtue of passage of articles through distinct operational zones (washing, rinsing and drying), without (as in the case of batch cleaners) having to reconfigure a single chamber for each distinct operation, each operation may proceed more quickly. As already alluded, batch cleaners, while taking up much less space, consume many multiples of processing time than do present in-line cleaners.

However fast the best of present in-line cleaners may be, or however small the most compact of present batch cleaners may be, there is always the compelling need for both faster, smaller, as well as increasingly effective board cleaning systems, and board cleaning methods involving their use. Such need is long-felt, yet never fully satisfied.

### SUMMARY OF THE INVENTION

In view of the foregoing, it is an object of the present invention to provide an effective circuit board cleaning apparatus which, while at least equal in effectiveness to presently available in-line cleaners, occupies substantially less floor space than present in-line cleaners.

It is another object of the present invention to provide an effective circuit board cleaning apparatus which is both substantially smaller than presently available, equivalent, or even less effective in-line cleaning apparatus, but substantially faster in processing time than presently available batch cleaning systems.

It is another object of the present invention to provide a circuit board cleaning system which occupies less space than comparably effective in-line systems, consumes less time than comparably effective batch systems, consumes less power than either batch or in-line systems, is less expensive to manufacture (and, therefore, can be offered to industry at a lesser purchase price), and involves fewer components to wear or malfunction than presently alternative systems.

It is another object of the present invention to provide a novel circuit board cleaning system and associated method for cleaning circuit boards through use of such system, which system both more effectively and more quickly cleans printed circuit boards and like manufactured items than presently available cleaning systems of any description, yet does so without the floor space or power consumption of the fastest presently available systems, nor the time consumption of the more compact, batch systems of present availability.

It is another object of the present invention to provide a novel circuit board cleaning system and associated method for cleaning circuit boards through use of such system, which new system, in some instances eliminates multiple costly components associated with presently available cleaning systems, and in other cases allows for smaller, less costly components when compared with such present systems.

In satisfaction of these and related objects, the present invention provides a new circuit board cleaning system and associated method for use thereof in the cleaning of printed circuit boards which satisfies each of the above objects. The present system involves an elongate enclosure which is functionally divided, in the preferred embodiment, into three operational zones—a washing zone, a rinsing zone, and a drying zone. In this respect, the new system resembles an in-line cleaning system.

Quite unlike any presently available in-line system, the new system utilizes a computer programmable, bi-directional conveyer system which moves to-be-cleaned boards past single banks of washing spray nozzles, rinsing spray nozzles and drying manifolds, at pre-programed velocities, sequences, and/or repeated cycles. Because of this configuration, to-be-cleaned boards are washed, cleaned and dries according to any desired processing profile which most effectively accomplishes the cleaning task.

For a particular cleaning job which in conventional in-line cleaners might require, for example, five spray nozzle banks for adequate cleaning fluid impingement, use of the present system would merely involve the use of a cleaning profile by which boards pass the single washing spray nozzle bank a five times through appropriate reversal of the bi-directional conveyer system. In this example, four spray nozzle banks are eliminated, and along with them the linear floor space consumed by the inevitably larger machine. Furthermore, the smaller, less power-consuming fluid pumps, and smaller fluid reservoirs are required for service one, rather than the five nozzle banks of this example.

The value of this new approach become even more apparent when one realizes that there is virtually no realistic limit to the number of wash, rinse or dying cycles (each independently determined by conveyor control system programming) when using the present system—something which, with conventional in-line systems, could only be matched with multiple, independent passes through the entire system. This, in turn, would involve considerable wasted time, as workers load and re-load the in-line systems. Even if this were an acceptable waste of labor time, selectively and independently controlling board exposure to washing, rinsing or drying cycles is not something which presently available systems are designed to do, or are capable of doing.

The preferred embodiment of the present invention is configured as a batch cleaning system. Thus, boards are loaded onto the conveyor at a single location, the cleaning and drying operations are completed, and the boards are removed at the same location. For several reasons, not the least of which is the elimination of end loading as is required for conventional in-line cleaning systems, with the attendant space consumption of loading ramps, etc., the present system preferably uses a centrally located access hatch through which racks with circuit boards loaded thereon are placed onto the bi-directional conveyor.

The access hatch, in the preferred embodiment, is centrally located with respect to the long axis of the apparatus enclosure, and its expanse includes the position, along such long axis, of the drying manifold. The present invention includes a certain optimal, relative placement of the drying manifold, washing nozzle assembly and rinsing nozzle assembly along the long axis of the cleaning system—an arrangement which optimizes functionality which consuming floor space at to an absolute minimum degree when considering the size of circuit boards or like articles which are to be cleaned.

As will be described in more detail later, the preferred embodiment of the present invention includes a particular, preferred design for its drying manifold which optimizes drying, particularly of such things as printed circuit boards, and thereby reduces the time consumed by the drying phase portion of any cleaning and drying cycle.

### BRIEF DESCRIPTION OF THE DRAWINGS

FIG. 1 is a conceptual diagram representing principally the primary elements of the present invention, substantially without the inclusion of well-known, conventional components used in forced liquid spraying and forced air drying systems of the relevant art.

### DETAILED DESCRIPTION OF THE PREFERRED EMBODIMENT

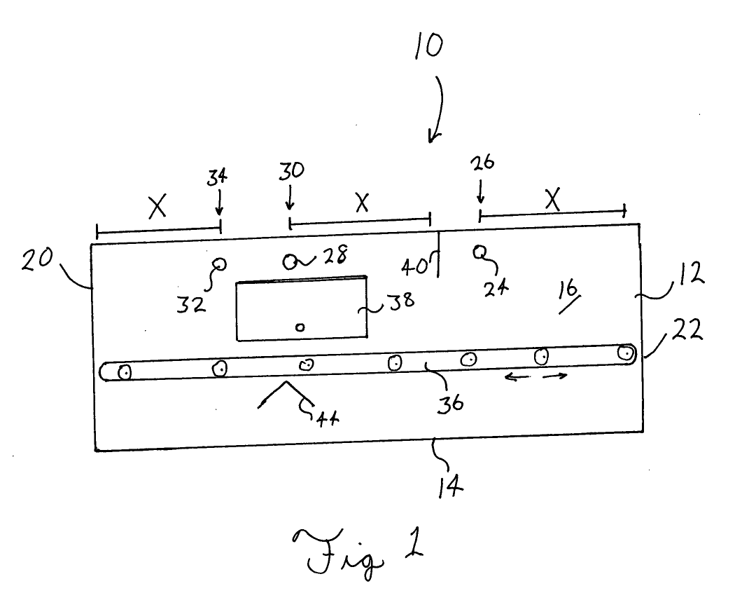

Referring to FIG. 1, the circuit board cleaning system of the present invention is depicted (somewhat schematically) in general by the reference number 10. System 10 includes an elongate enclosure 12 with a base or floor member 14, side walls 16 (only front side wall visible in drawing), a top or ceiling panel 18. For ease of description, the distal ends of enclosure 12 are (as if viewed from the front side) referred to as the left end (or first end) 20 and the right end (or second end) 22.

A washing nozzle assembly 24 resides at, and defines a first linear position 26 relative to the long axis of enclosure 12. A drying manifold 28 resides at, and defines a second linear position 30. A rinsing nozzle assembly 32 resides at, and defines a third linear position 34. Suitable designs for washing nozzle assembly 24 and rinsing nozzle assembly 32, as well as the associated pumps, conduits, valves, actuating systems, and distance from work piece parameters are well known in the circuit board cleaning art, and are, therefore, neither detailed here, nor required for an enabling disclosure.

However, the preferred embodiment of the present invention includes a drying system of a particular description. Previously described in U.S. Pat. No. 6,108,938, the Jones drying system is found to be optimal for use in the present system 10. The substantially enhanced drying efficiency of the Jones design for air flow drying systems affords a very thorough and rapid drying portion of a processing cycle. The disclosure of U.S. Pat. No. 6,108,938 is incorporated herein by reference.

A bi-directional conveyor assembly 36 is positioned within enclosure 12 and extends substantially from the first end 20 to the second end 22, and is configured for carrying articles placed thereon past and underneath each of washing nozzle 24, drying manifold 28, and rinsing nozzle assembly 32.

Bi-directional conveyor assembly 36, according to conventional conveyor design, includes one or more motors (not shown in the drawings) which effect cyclical, linear movement of the constituent conveyor belt. According to the present invention, the motor(s) of conveyor assembly 36 are variable RPM and bi-directional motors, or are linked to the actual conveyor belt via a reversible transmission means. Also, a conveyor actuation or control system (not shown in the drawings) controls the motor(s) of the conveyor assembly 36 with respect to the starting and stopping of conveyor belt movement, as well as the direction and velocity of movement thereof.

Although a wide array of design choices are possible for the conveyor assembly 36 as part of an embodiment of the present invention, merely a few of the available examples of suitable constituent systems and components may be drawn from U.S. Pat. No. 6,116,410 to Malmberg, U.S. Pat. No. 6,116,410 to Hovst.o slashed, et al, U.S. Pat. No. 5,850,906 to Dean, U.S. Pat. No. 4,991,719 to Butcher, and U.S. Pat. No. 4,924,164 to Riley, the respective disclosures of which are here incorporated by reference.

Whether integral to the conveyor actuation system, or a separate, but interfaced system, additional control features involve the actuation of the respective pumps and blower components (not shown in the drawings) which are associated with the washing nozzle assembly 24, drying manifold 28, and rinsing nozzle assembly 32 as articles placed on conveyor assembly 36 thereunder and are, according to a desired washing, cleaning a drying profile, to be acted upon by such components. Examples of analogous design approaches for such a control and actuation system, or portions thereof, are provided in U.S. Pat. No. 5,479,352 to Smith, U.S. Pat. No. 5,741,558 to Otani, et al. and U.S. Pat. No. 4,159,806 to Scharfenberger, the disclosures of which is here incorporated by reference.

An access hatch 38 is, in the preferred embodiment, positioned medially of enclosure 12. Items placed on conveyor assembly 36 for processing by system 10 are to be placed within a delineated length of the conveyor belt (most likely in racks for supporting the items in an optimal orientation, as well as to prevent their “blowing off” the conveyor assembly during processing), so that the items begin and end at a proper linear position within enclosure 10, and most importantly, pass beneath washing nozzle assembly 24, drying manifold 28, and rinsing nozzle assembly 32 at the appropriate times for proper processing. Such proper placement may be insured by clearly visible marks on the conveyor belt, with users being instructed to always place to-be-processed items between such marks. In the alternative, some sensor arrangement may “sense” the position of articles or racks carrying articles relative to one or more of washing nozzle assembly 24, drying manifold 28, and/or rinsing nozzle assembly 32 to insure appropriate and timely actuation thereof.

The positions of washing nozzle assembly 24, drying manifold 28, and rinsing nozzle assembly 32, relative to each other as well as to the distal ends 20 and 22 of enclosure 12 are important features in the preferred embodiment of the present invention. Such proper relative spacing insures that articles of certain maximum sizes can be fully and effectively process with system 10, yet linear space consumed by the apparatus is kept to a bare minimum.

An example of such optimum spacing and arrangement is given for items, or racks of items, which occupy fifteen inches (15″) lengthwise on conveyor assembly 36. For processing items of this size, an exemplary arrangement, using second end 20 as the zero point, involves optimal positions as follows: washing nozzle assembly 24 and position first position is at seventeen inches (17″), a partition 40 between the washing area and the drying area inside enclosure 12 lies at twenty five inches (25″), drying manifold 28 at position two lies at forty two inches (42″), rinsing nozzle assembly 32 and position three resides at fifty inches (50″), and the first end 22 of enclosure 12 lies at sixty six inches (66″).

Examination of FIG. 1 reveals that, for processing such a fifteen inch long article, and involving the positioning of components just described, the article can be carried on conveyor assembly 36, first to the right completely beneath and beyond washing nozzle assembly 24, then back toward the left, past drying manifold 28 (to initially “strip off” residual washing fluid which is directed into a collection reservoir by vane 44) to pass beneath and fully beyond rinsing nozzle assembly 32, and finally at least one full pass (back to the right) beneath drying manifold 28. As mentioned before, any one of the passages may be repeated multiple times. Because the drying system which feeds drying manifold 28 can be controlled for actuation only when needed, there is no need for a larger than approximately an eight inch (8″) distance between drying manifold 28 and rinsing nozzle assembly 32. As with the systems which “feed” washing nozzle assembly 24 and rinsing nozzle assembly 32, the drying component can be inactive when unneeded, and in particular during multiple (back-and-forth) passages beneath rinsing nozzle assembly 32 whereby pre-mature drying might occur. Thus, there is no need to insure adequate distance (sixteen inches or so) between rinsing nozzle assembly 32 and drying manifold 28 to prevent a fifteen inch (15″) article from passing at all beneath drying manifold 28 during a rinsing operation.

The preferred embodiment of the present invention provides a spacing of approximately eight inches (8″) between drying manifold 28 and both rinsing nozzle assembly 32 and washing nozzle assembly 24. Presently, this is believed to be an approximate, appropriate distance to keep a completely processed, fully dried board from beneath either assembly where dripping could re-contaminate the board (the conveyor assembly 36 will position such an article essentially centered under drying manifold 28 upon completion of a cycle, according to the preferred mode of the present invention).

Clearly, this same approach should be applied for configuring a system 10 for processing articles which are consistently larger or smaller than the exemplified fifteen inch (15″) article, with the dimensions above simply being adjusted substantially in proportion to the difference (more or less) from the fifteen inches (15″). For a system 10 designed to consistently wash and dry seventeen inch (17″) long items, all dimensions described above would be increased by two inches (2″), while for processing twelve inch (12″) items, such dimensions would be decreased by three inches (3″), and so forth. One qualification of this general guidance is that, optimally (although not absolutely critical), the distance between drying manifold 28 and rinsing nozzle assembly 32 should not be less than the above described eight inches (8″), in order to avoid undue splashing and over-spray from the rinsing area of enclosure 12 into the drying area thereof.

As shown in FIG. 1, the critical, relative distances between the ends of conveyor 36, washing nozzle assembly 24, drying manifold 28, and rinsing nozzle assembly 32 may be expressed as a variable “X”, where X represents the maximum sized article (measured lengthwise) which may be optimally processed using the present system.

Mock-up studies of the proposed design indicate that embodiments of the present invention will afford both substantial space and processing time savings, when compared to any presently available device, whether batch or in-line.

Nothing of this nature has yet been proposed or achieved in the printed circuit board manufacturing industry. Perhaps blind adherence to the assumption that the presently available alternatives of in-line or batch cleaners are the only viable choices (in essence, speed versus footprint) have resulted in incalculable wasted floor space consumption, power consumption, manufacturing delays, needless labor costs, repair bills and acquisition costs, all of which are quite favorably addressed by embodiments of the present invention.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

1. An apparatus for cleaning and drying manufactured components comprising:
an enclosure defining an elongate interior space, delimited by a base, side walls and a top wall;
bi-directional conveyor means positioned within said enclosure, residing near said base and extending substantially along a long axis of said interior space;
conveyor actuation means configured for actuating said bi-directional conveyor means to carry articles placed thereon within said enclosure according to user-selected velocities, pause intervals and/or directions;
first spray nozzle assembly means positioned at a first position within said enclosure, said first spray nozzle assembly means being in fluid communication with a pump, conduit and washing solution reservoir assembly and being oriented for, upon actuation, spraying a washing solution upon articles positioned on said bi-directional conveyor means and carried thereby under said first spray nozzle assembly;
drying manifold means positioned at a second position within said enclosure, said drying manifold means being operably connected to air propulsion means for receiving forced air and oriented for projecting said forced air upon articles positioned on said bi-directional conveyor means and carried thereby under said drying manifold means.

2. The apparatus of claim 1 further comprising:
second spray nozzle assembly means positioned at a third position within said enclosure, said second spray nozzle assembly means being in fluid communication with a pump, conduit and rinsing agent reservoir assembly and being oriented for, upon actuation, spraying a rinsing agent upon articles positioned on said conveyor means and carried thereby under said second spray nozzle assembly.

3. The apparatus of claim 2 wherein said enclosure is fitted with an access aperture for providing access to said conveyor means for placing said articles thereon.

4. The invention of claim 3 wherein said access aperture is positioned substantially centrally of said enclosure, the linear expanse of which includes said second position, and wherein said first position lies in a first lateral direction from said access aperture, and said third position lies in a second lateral direction from said access aperture, and further wherein said bi-directional conveyor means extends laterally beyond said first and said third positions each at a sufficient length to enable carrying said articles placed on said bi-directional conveyor means fully, laterally distal of said first spray nozzle assembly means and said second spray nozzle assembly means.

5. The invention of claim 3 wherein said access aperture is positioned substantially at a first end of said enclosure and wherein said first position lies adjacent said access aperture, said second position lies at a more distal position from said first end, and said third position lies at a still more distal position from said first end, and further wherein said conveyor actuation means is configured for first carrying said articles placed on said bi-directional means past said first spray nozzle assembly means, reversing direction and carrying said articles past said second spray assembly means, and again reversing direction for carrying said articles past said drying manifold means.

6. The invention of claim 4 wherein said conveyor actuation means is configured for first carrying said articles placed on said bi-directional means past said first spray nozzle assembly means, reversing direction and carrying said articles past said second spray assembly means, again reversing direction for carrying said articles past said drying manifold means.

7. The invention of claim 2 wherein said bi-conveyor actuation means is configured for moving said bi-directional conveyor means whereby articles placed thereon are carried multiple times past one or more of said first spray nozzle assembly means, said second spray nozzle assembly means, and said drying manifold means.

8. The invention of claim 4 wherein said bi-conveyor actuation means is configured for moving said bi-directional conveyor means whereby articles placed thereon are carried multiple times past one or more of said first spray nozzle assembly means, said second spray nozzle assembly means, and said drying manifold means.

9. The invention of claim 6 wherein said conveyor actuation means is configured for moving said bi-directional conveyor means whereby articles placed thereon are carried multiple times past one or more of said first spray nozzle assembly means, said second spray nozzle assembly means, and said drying manifold means.

10. The invention of claim 2 wherein said apparatus is configured for washing and drying articles of length X, said first spray nozzle assembly means lies at a linear position approximately X distance along said conveyor means from a first terminus of said conveyor means, near a first end of said enclosure, said second spray nozzle assembly means lies approximately X distance from a second terminus of said conveyor means near a second end of said enclosure, and said drying manifold means lies not less than approximately X distance from said first spray nozzle assembly and said second spray nozzle assembly.

11. The invention of claim 10 wherein said bi-conveyor actuation means is configured for moving said bi-directional conveyor means whereby articles placed thereon are carried multiple times past one or more of said first spray nozzle assembly means, said second spray nozzle assembly means, and said drying manifold means.

12. The invention of claim 4 wherein said bi-conveyor actuation means is configured for moving said bi-directional conveyor means whereby articles placed thereon are carried multiple times past one or more of said first spray nozzle assembly means, said second spray nozzle assembly means, and said drying manifold means and wherein said apparatus is configured for washing and drying articles of length X, said first spray nozzle assembly means lies at a linear position approximately X distance along said conveyor means from a first terminus of said conveyor means, near a first end of said enclosure, said second spray nozzle assembly means lies approximately X distance from a second terminus of said conveyor means near a second end of said enclosure, and said drying manifold means lies not less than approximately X distance from said first spray nozzle assembly and said second spray nozzle assembly.

13. The invention of claim 6 wherein said bi-conveyor actuation means is configured for moving said bi-directional conveyor means whereby articles placed thereon are carried multiple times past one or more of said first spray nozzle assembly means, said second spray nozzle assembly means, and said drying manifold means and wherein said apparatus is configured for washing and drying articles of length X, said first spray nozzle assembly means lies at a linear position approximately X distance along said conveyor means from a first terminus of said conveyor means, near a first end of said enclosure, said second spray nozzle assembly means lies approximately X distance from a second terminus of said conveyor means near a second end of said enclosure, and said drying manifold means lies not less than approximately X distance from said first spray nozzle assembly and said second spray nozzle assembly.

14. A method for cleaning electronic components comprising the steps of:
selecting an apparatus for cleaning and drying manufactured components comprising:
an enclosure defining an elongate interior space, delimited by a base, side walls and a top wall;
bi-directional conveyor means positioned at least partially within said enclosure, residing near said base and extending substantially along a long axis of said interior space;
conveyor actuation means configured for actuating said bi-directional conveyor means to carry articles placed thereon within said enclosure according to user-selected velocities, pause intervals and/or directions, said conveyor means being configured for first carrying said articles placed on said bi-directional means past said first spray nozzle assembly means, reversing direction and carrying said articles past said second spray assembly means, again reversing direction for carrying said articles past said drying manifold means;
first spray nozzle assembly means positioned at a first position within said enclosure, said first spray nozzle assembly means being in fluid communication with a pump, conduit and washing solution reservoir assembly and being oriented for, upon actuation, spraying a washing solution upon articles positioned on said bi-directional conveyor means and carried thereby under said first spray nozzle assembly;
drying manifold means positioned at a second position within said enclosure, said drying manifold means being operably connected to air propulsion means for receiving forced air and oriented for projecting said forced air upon articles positioned on said bi-directional conveyor means and carried thereby under said drying manifold means;
second spray nozzle assembly means positioned at a third position within said enclosure, said second spray nozzle assembly means being in fluid communication with a pump, conduit and rinsing agent reservoir assembly and being oriented for, upon actuation, spraying a rinsing agent upon articles positioned on said conveyor means and carried thereby under said second spray nozzle assembly;
an access aperture positioned substantially centrally of said enclosure, the linear expanse of which includes said second position, and wherein said first position lies in a first lateral direction from said access aperture, and said third position lies in a second lateral direction from said access aperture, and further wherein said bi-directional conveyor means extends laterally beyond said first and said third positions each at a sufficient length to enable carrying said articles placed on said bi-directional conveyor means fully, laterally distal of said first spray nozzle assembly means and said second spray nozzle assembly means;
placing to-be-cleaned articles on said bi-directional conveyor means; and
actuating said conveyor actuation means.

15. The method of claim 10 wherein said conveyor actuation means is further configured whereby said carrying of said articles past one of more of said first spray nozzle assembly means, said second spray nozzle assembly means, and said drying manifold means involves multiple passages there past.

16. The method of claim 14 wherein said bi-conveyor actuation means is configured for moving said bi-directional conveyor means whereby articles placed thereon are carried multiple times past one or more of said first spray nozzle assembly means, said second spray nozzle assembly means, and said drying manifold means and wherein said apparatus is configured for washing and drying articles of length X, said first spray nozzle assembly means lies at a linear position approximately X distance along said conveyor means from a first terminus of said conveyor means, near a first end of said enclosure, said second spray nozzle assembly means lies approximately X distance from a second terminus of said conveyor means near a second end of said enclosure, and said drying manifold means lies not less than approximately X distance from said first spray nozzle assembly and said second spray nozzle assembly.
